(19) United States
(12) Patent Application Publication
(10) Pub. No.: US 2023/0243052 A1
(43) Pub. Date: Aug. 3, 2023

(54) OXIDATION ELECTRODE AND ELECTROCHEMICAL REACTION DEVICE USING THE SAME

(71) Applicant: KABUSHIKI KAISHA TOSHIBA, Tokyo (JP)

(72) Inventors: Asahi MOTOSHIGE, Ota (JP); Ryota KITAGAWA, Setagaya (JP); Akihiko ONO, kita (JP); Yoshitsune SUGANO, Kawasaki (JP); Yuki KUDO, Yokohama (JP); Jun TAMURA, Chuo (JP); Masakazu YAMAGIWA, Yokohama (JP); Satoshi MIKOSHIBA, Yamato (JP)

(73) Assignee: KABUSHIKI KAISHA TOSHIBA, Tokyo (JP)

(21) Appl. No.: 18/299,230

(22) Filed: Apr. 12, 2023

Related U.S. Application Data
(63) Continuation of application No. 16/560,332, filed on Sep. 4, 2019.
Application No. 16/560,332 is a continuation of application No. PCT/JP2018/033312, filed on Sep. 7, 2018.

(30) Foreign Application Priority Data
Mar. 22, 2018 (JP) 2018-054096

(51) Int. Cl. C25B 11/091; C25B 1/04; C25B 3/25; C25B 9/23; C25B 9/73; C25B 11/051; C25B 11/057

(52) U.S. Cl. CPC C25B 11/091; C25B 1/04; C25B 3/25; C25B 9/23; C25B 9/73; C25B 11/051; C25B 11/057

(57) ABSTRACT

A CO₂ electrolyzing method may include: supplying gas containing CO₂ and/or a first electrolytic solution (ES) containing CO₂ to a first accommodation part (AP) of an electrolysis cell so the gas or first ES contacts a reduction electrode in the first AP, the electrolysis cell including the reduction electrode, an oxidation electrode, the first AP, and a second AP; supplying a second ES containing water and CO₂, HCO₃⁻, and/or CO₃²⁻ to the second AP so the second ES contacts the oxidation electrode in the second AP, the oxidation electrode including a conductive metal substrate and oxidation catalyst layer thereon, of a 20 to 70 mass% Fe, balance Ni, a nickel and iron bonding state in the composite body including Ni(OH)₂, NiOOH, and FeOOH; supplying an electric current to the reduction and oxidation electrode, to reduce the CO₂ in the reduction electrode and produce a carbon compound.

### CROSS REFERENCE TO RELATED APPLICATION

The present application is a continuation of U.S. Appl. Ser. No. 16/560,332, filed Sep. 4, 2019, and published as US 2020/0002827 A1, which was a by-pass continuation of International Application No. PCT/JP2018/033312, filed on Sep. 7, 2018, claiming the benefit of priority from Japanese Patent Application No. 2018-054096, filed on Mar. 22, 2018, the content of each of which is incorporated by reference herein in its entirety.

### FIELD

Embodiments described herein relate generally to an oxidation electrode and an electrochemical reaction device using the same.

### BACKGROUND

In recent years, there is a concern over depletion of fossil fuel such as petroleum and coal, and expectations of sustainably usable renewable energy increases. Examples of the renewable energy include a solar cell, wind power generation and so on. Their power generation amounts depend on weather and natural status and therefore have a problem of difficulty in stable supply of power. Therefore, it is tried to store power generated with the renewable energy in a storage battery so as to stabilize the power supply. However, the storage of power has a problem of requiring cost for the storage battery or causing a loss during storage of power.

In regard the above point, there is a technique attracting attention which performs water electrolysis using power generated with the renewable energy to produce hydrogen (H₂) from water or to electrochemically reduce carbon dioxide (CO₂) to convert it into chemical substances (chemical energy) such as carbon monoxide (CO), formic acid (HCOOH), methanol (CH₃OH), and the like. In the case of storing these chemical substances in a cylinder or a tank, there are advantages that the storage cost for the energy can be reduced and the storage loss is small as compared with the case of storing the power (electric energy) in the storage battery.

An electrochemical reaction device reducing carbon dioxide includes a cathode (reduction electrode) which reduces carbon dioxide (CO₂) to produce a carbon compound and an anode (oxidation electrode) which oxidizes water (H₂O) to produce oxygen. The anode and the cathode in the electrochemical reaction device are immersed in an aqueous solution (electrolytic solution) containing, for example, carbon dioxide and electrolyte. The anode has an oxidation catalyst layer provided, for example, on a conductive substrate. As the oxidation catalyst, oxide, hydroxide or the like of Ir, Mn, Ni, Fe or the like is used. When the oxidation of H₂O and the reduction of CO₂ are performed by the electrochemical reaction device including the above electrodes, the oxidation catalyst layer may be likely to peel from the conductive substrate in the electrolytic solution. In order to improve the efficiency and the durability of the electrochemical reaction device, it is necessary, for example, not only to enhance the oxidation performance for water by the oxidation catalyst but also to enhance the durability of the oxidation electrode (anode) including the oxidation catalyst layer to the electrolytic solution.

### BRIEF DESCRIPTION OF THE DRAWINGS

FIG. 1 is a view illustrating an electrochemical reaction device according to a first embodiment.

FIG. 2 is a cross-sectional view illustrating an oxidation electrode in the electrochemical reaction device illustrated in FIG. 1.

FIG. 3 is a view illustrating an electrochemical reaction device according to a second embodiment.

FIG. 4 is a chart illustrating a temporal change in anode potential by a constant-current measurement of the anode using electrochemical reaction devices in Example 1 and Comparative Example 1.

FIG. 5 is a chart illustrating measurement results of the Raman spectra of the anodes in the electrochemical reaction devices in Example 1 and Comparative Example 1.

FIG. 6 is a chart illustrating a temporal change in anode potential in a constant-current measurement of the anode using an electrochemical reaction device in Example 2.

FIG. 7 is a chart illustrating a temporal change in cell voltage in a constant-current measurement of the anode using the electrochemical reaction device in Example 2.

### DETAILED DESCRIPTION

An oxidation electrode in an embodiment includes: a conductive substrate made of a metal material including titanium, titanium alloy, or stainless steel; and an oxidation catalyst layer provided on the conductive substrate and made of a composite body containing nickel and iron. A bonding state of nickel and iron in the composite body containing nickel and iron is composed of Ni(OH)₂, NiOOH, and FeOOH.

Electrochemical reaction devices in embodiments will be explained hereinafter with reference to the drawings. Note that substantially the same components are denoted by the same reference signs and explanation thereof may be omitted in some cases in the embodiments. The drawings are schematic, and the relation between thicknesses and plane dimensions of parts, ratios between the thicknesses of the parts and the like may differ from actual ones.

### First Embodiment

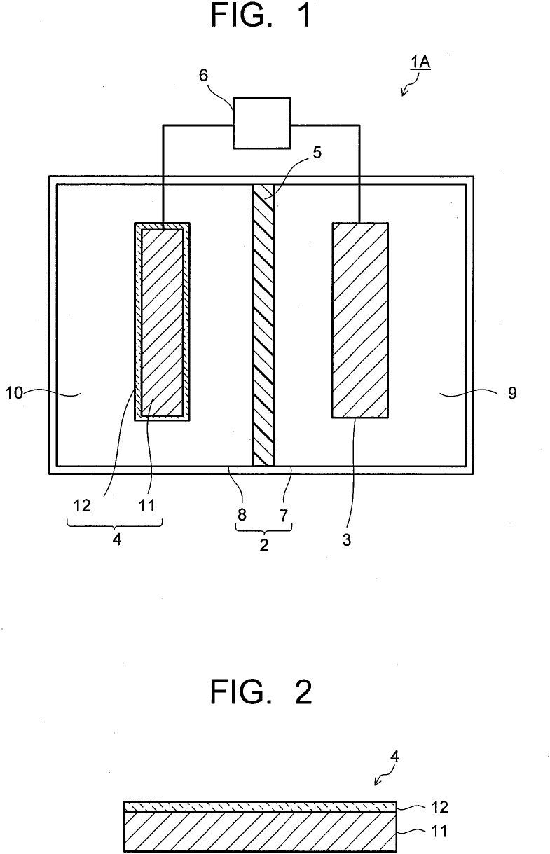

FIG. 1 is a view illustrating an electrochemical reaction device 1 in a first embodiment. An electrochemical reaction device 1A illustrated in FIG. 1 reduces carbon dioxide (CO₂) to produce a carbon compound and oxidizes water (H₂O) to produce oxygen. The electrochemical reaction device 1A includes an electrolytic solution tank 2, a cathode 3, an anode 4, an ion exchanger 5, and a power supply 6.

The electrolytic solution tank 2 is separated into two chambers by the ion exchanger 5 capable of moving ions such as hydrogen ions (H⁺) and hydroxide ions (OH⁻) and the like, and has a first accommodation part 7 and a second accommodation part 8. The electrolytic solution tank 2 contains, for example, quartz white plate glass, polystyrol, polymethacrylate or the like. A material transmitting light may be used for a part of the electrolytic solution tank 2, and a resin material may be used for the remainder. Examples of the resin material include polyetheretherketone (PEEK), polyamide (PA), polyvinylidene fluoride (PVDF), polyacetal (POM) (copolymer), polyphenyleneether (PPE), acrylonitrile-butadiene-styrene copolymer (ABS), polypropylene (PP), polyethylene (PE) and so on.

In the first accommodation part 7, the cathode 3 is arranged and a first electrolytic solution 9 is accommodated. The first electrolytic solution 9 functions as a cathode solution and contains a substance to be reduced such as carbon dioxide (CO₂). The first electrolytic solution 9 may contain hydrogen ions and is preferably an aqueous solution. In the second accommodation part 8, the anode 4 is arranged and a second electrolytic solution 10 is accommodated. The second electrolytic solution 10 functions as an anode solution and contains water (H₂O) as a substance to be oxidized. The second electrolytic solution 10 may be an alcohol aqueous solution or an organic aqueous solution of amine or the like.

It is possible to change the amount of water and electrolytic solution components contained in the first and second electrolytic solutions 9, 10 to thereby change the reactivity so as to change the selectivity of the substance to be reduced and the ratio of the chemical substances to be produced. The first and second electrolytic solutions 9, 10 may contain redox couples as needed. Examples of the redox couple include Fe³⁺/Fe²⁺ and IO³⁻/I⁻. The first and second accommodation parts 7, 8 may include space parts for accommodating gases contained in the reactant and the product. Further, flow paths and the like connected to the first and second accommodation parts 7, 8 may be provided. The flow paths may be used as an electrolytic solution flow path and a product flow path. The first and second accommodation parts 7, 8 may have stirrers for stirring the electrolytic solutions 9, 10.

The second electrolytic solution 10 may contain the same substance as that in the first electrolytic solution 9. In this case, the first electrolytic solution 9 and the second electrolytic solution 10 may be regarded as one electrolytic solution. Besides, the pH of the second electrolytic solution 10 is preferably higher than the pH of the first electrolytic solution 9. This makes the hydrogen ions, the hydroxide ions and so on easy to move. Further, the liquid junction potential due to the difference in pH can effectively promote the oxidation-reduction reaction.

Examples of the electrolytic solution containing carbon dioxide applicable to the first electrolytic solution 9 include aqueous solutions containing hydrogencarbonates and carbonates such as lithium hydrogen carbonate (LiHCO₃), sodium hydrogen carbonate (NaHCO₃), potassium hydrogen carbonate (KHCO₃), sodium carbonate (Na₂CO₃), potassium carbonate (K₂CO₃), and cesium hydrogen carbonate (CsHCO₃), phosphoric acid, boric acid, and so on. The electrolytic solution containing carbon dioxide may contain alcohols such as methanol, ethanol, acetone and the like. The second electrolytic solution 10 containing water may be the same as the first electrolytic solution 9 containing carbon dioxide, and the absorption amount of carbon dioxide in the first electrolytic solution 9 containing carbon dioxide is preferably high. Accordingly, a solution different from the second electrolytic solution 10 containing water may be used as the first electrolytic solution 9 containing carbon dioxide. The first electrolytic solution 9 containing carbon dioxide is preferably an electrolytic solution that lowers the reduction potential for carbon dioxide, has high ion conductivity, and contains a carbon dioxide absorbent that absorbs carbon dioxide.

As the electrolytic solution containing water applicable to the second electrolytic solution 10, an aqueous solution containing an arbitrary electrolyte can be used. The solution is preferably an aqueous solution that promotes the oxidation reaction of water. Examples of the aqueous solution containing the electrolyte include aqueous solutions containing phosphate ions (PO₄²⁻), borate ions (BO₃³⁻), sodium ions (Na⁺), potassium ions (K⁺), calcium ions (Ca²⁺), lithium ions (Li⁺), cesium ions (Cs⁺), magnesium ions (Mg²⁺), chloride ions (Cl⁻), hydrogen carbonate ions (HCO₃⁻), carbonate ions (CO₃⁻), and the like.

As the above-described electrolytic solutions, for example, ionic liquids made of salts of cations such as an imidazolium ion and a pyridinium ion and anions such as BF₄⁻ and PF₆⁻ and in a liquid state in a wide temperature range, or aqueous solutions thereof can be used. Further, examples of other electrolytic solutions include amine solutions such as ethanolamine, imidazole, and pyridine, and aqueous solutions thereof. Examples of amine include primary amine, secondary amine, tertiary amine, and so on. The electrolytic solutions may be high in ion conductivity and have properties of absorbing carbon dioxide and characteristics of lowering the reduction energy.

Examples of the primary amine include methylamine, ethylamine, propylamine, butylamine, pentylamine, hexylamine and the like. The hydrocarbon of the amine may be substituted by alcohol, halogen or the like. Examples of amine whose hydrocarbon is substituted include methanolamine, ethanolamine, chloromethylamine and the like. Further, an unsaturated bond may exist. These hydrocarbons are also the same in the secondary amine and the tertiary amine.

Examples of the secondary amine include dimethylamine, diethylamine, dipropylamine, dibutylamine, dipentylamine, dihexylamine, dimethanolamine, diethanolamine, dipropanolamine and the like. The substituted hydrocarbons may be different. This also applies to the tertiary amine. Examples with different hydrocarbons include methylethylamine, methylpropylamine and the like.

Examples of the tertiary amine include trimethylamine, triethylamine, tripropylamine, tributylamine, trihexylamine, trimethanolamine, triethanolamine, tripropanolamine, tributanolamine, tripropanolamine, triexanolamine, methyldiethylamine, methyldipropylamine and the like.

Examples of the cation of the ionic liquid include a 1-ethyl-3-methylimidazolium ion, a 1-methyl-3-propylimidazolium ion, 1-butyl-3-methylimidazole ion, a 1-methyl-3-pentylimidazolium ion, a 1-hexyl-3-methylimidazolium ion, and the like.

A second place of the imidazolium ion may be substituted. Examples of the cation in which the second place of the imidazolium ion is substituted include a 1-ethyl-2,3-dimethylimidazolium ion, a 1,2-dimethyl-3-propylimidazolium ion, a 1-butyl-2,3-dimethylimidazolium ion, a 1,2-dimethyl-3-pentylimidazolium ion, a 1-hexyl-2,3-dimethylimidazolium ion, and the like.

Examples of the pyridinium ion include methylpyridinium, ethylpyridinium, propylpyridinium, butylpyridinium, pentylpyridinium, hexylpyridinium and the like. In both of the imidazolium ion and the pyridinium ion, an alkyl group may be substituted, or an unsaturated bond may exist.

Examples of the anion include a fluoride ion (F⁻), a chloride ion (Cl⁻), a bromide ion (Br⁻), an iodide ion (I⁻), BF₄⁻, PF₆⁻, CF₃COO⁻, CF₃SO₃⁻, NO₃⁻, SCN⁻, (CF₃SO₂)₃C⁻, bis(trifluoromethoxysulfonyl)imide, bis(trifluoromethoxysulfonyl)imide, bis(perfluoroethylsulfonyl)imide and the like. Dipolar ions in which the cations and the anions of the ionic liquid are coupled by hydrocarbons may be used. Note that a buffer solution such as a potassium phosphate solution may be supplied to the accommodation parts 7, 8.

The cathode 3 is a cathode for an electrochemical reaction device and is a reduction electrode that reduces carbon dioxide (CO₂) to produce a carbon compound. The cathode 3 is arranged in the first accommodation part 7 and immersed in the first electrolytic solution 9. The cathode 3 contains, for example, a reduction catalyst for producing a carbon compound and hydrogen by the reduction reaction of, for example, carbon dioxide. Examples of the reduction catalyst include a material that lowers activation energy for reducing carbon dioxide. In other words, a material that lowers an overvoltage when the carbon compound is produced by the reduction reaction of carbon dioxide can be exemplified.

For example, a metal material or a carbon material can be used as the cathode 3. As the metal material, for example, a metal such as gold, aluminum, copper, silver, platinum, palladium, or nickel, or an alloy containing the metal can be used. As the carbon material, for example, graphene, carbon nanotube (CNT), fullerene, ketjen black or the like can be used. Note that the reduction catalyst is not limited to the above but, for example, a metal complex such as a Ru complex or a Re complex, or an organic molecule having an imidazole skeleton or a pyridine skeleton may be used as the reduction catalyst. A mixture of a plurality of materials may also be used.

The carbon compound produced by the reduction reaction differs depending on the kind or the like of the reduction catalyst, and examples of thereof include carbon monoxide (CO), formic acid (HCOOH), methane (CH₄), methanol (CH₃OH), ethane (C₂H₆), ethylene (C₂H₄), ethanol (C₂H₅OH), formaldehyde (HCHO), ethylene glycol and so on.

The reduction catalyst can achieve regeneration from a deteriorated state by addition of a chemical compound having a cleaning action through electrical oxidation and reduction of cyclic voltammetry (CV) or the cleaning effect by heat, light or the like. The cathode 3 is preferably the one that can be used for or withstand the regeneration of the reduction catalyst. Further, the electrochemical reaction device 1A preferably has such a regenerating function for the reduction catalyst.

The cathode 3 may have, for example, a structure in a thin film shape, a mesh shape, a particle shape, a wire shape, or the like. The reduction catalyst does not always have to be provided in the cathode 3. A reduction catalyst provided outside the cathode 3 may be electrically connected to the cathode 3.

The anode 4 is an anode for an electrochemical reaction device and is an oxidation electrode that oxidizes water (H₂O) to produce oxygen. The anode 4 is arranged in the second accommodation part 8 and immersed in the second electrolytic solution 10. The anode 4 includes a conductive substrate 11 and an oxidation catalyst layer 12 provided on the conductive substrate 11 as illustrated in FIG. 2. The oxidation catalyst layer 12 is provided in contact with the surface of the conductive substrate 11. The conductive substrate 11 is not limited to a plate shape but may be a porous shape, a thin film shape, a mesh shape, a particle shape, a wire shape, or the like

As the conductive substrate 11, a metal substrate made of a metal material including titanium, titanium alloy, or stainless steel is used. The use of the metal substrate made of titanium, titanium alloy, or stainless steel excellent in corrosion resistance improves the durability of the conductive substrate 11 in the second electrolytic solution 10 and can suppress the peeling or the like of the oxidation catalyst layer 12 from the conductive substrate 11. The titanium alloy only needs to be the one containing titanium as a main component (for example, a content of titanium of 70 mass% or more) and not impairing the corrosion resistance and so on of titanium. Examples of the metal element forming the titanium alloy include Al, Zr, V, Nb, Ta, Cr, Mo, W, Fe, Co, Pd, Sn, and so on.

In particular, since the corrosion resistance and so on of the conductive substrate 11 are maintained even in the case where the second electrolytic solution 10 contains hydrogen carbonate ions (HCO₃⁻), carbonate ions (CO₃²⁻), or the like, peeling and the like of the oxidation catalyst layer 12 from the conductive substrate 11 can be suppressed. The hydrogen carbonate ions (HCO₃⁻) and carbonate ions (CO₃²⁻) may be contained as a part of the electrolyte in the second electrolytic solution 10, or may be produced from the carbon dioxide (CO₂) in the first electrolytic solution 9 and move into the second electrolytic solution 10 through the ion exchanger 5. In any case, the ions are factors that cause a decrease in durability of the anode 4, but the use of the conductive substrate 11 made of the metal material as described above can improve the durability of the anode 4.

The oxidation catalyst layer 12 contains an oxidation catalyst for oxidizing water to produce oxygen and so on. As the oxidation catalyst, a material that lowers activation energy for oxidizing water is used. In other words, a material that lowers an overvoltage when oxygen and hydrogen ions are produced by the oxidation reaction of water is used. In the electrochemical reaction device 1A in the embodiment, a composite body containing nickel and iron, specifically, a composite body composed of nickel and iron is used as the oxidation catalyst for water. In the oxidation catalyst layer 12 made of the composite body of nickel and iron, the bonding state of nickel and iron is preferably composed of nickel hydroxide (II) (Ni(OH)₂), nickel oxyhydroxide (NiOOH), and iron oxyhydroxide (FeOOH). Use of the composite body of nickel and iron having the above bonding state (existing state) can increase the oxidation reaction efficiency of water in the oxidation catalyst layer 12 and increase the durability in the second electrolytic solution 10.

The bonding state of nickel and iron composed of Ni(OH)₂, NiOOH, and FeOOH can be specified by Raman spectroscopic analysis. More specifically, the Raman spectrum of the oxidation catalyst layer 12 provided on the conductive substrate 11 measured by the Raman spectroscopic analysis preferably has a first peak in a Raman shift of 170 cm⁻¹ or more and 350 cm⁻¹ or less, has a second peak in a Raman shift of 450 cm⁻¹ or more and 570 cm⁻¹ or less, and a third peak in a Raman shift of 650 cm⁻¹ or more and 700 cm⁻¹ or less. From the Raman spectrum having the peaks, it can be confirmed that the bonding state of nickel and iron is composed of Ni(OH)₂, NiOOH, and FeOOH.

In the composite body of nickel and iron constituting the oxidation catalyst layer 12, the content of iron is preferably 20 mass% or more and 70 mass% or less. In both of the case where the content of iron is less than 20 mass% and the case where the content of iron is more than 70 mass%, the performance of oxidizing water may become insufficient. Note that the oxidation catalyst layer 12 may contain, other than nickel and iron, a small amount of another metal element in a range not inhibiting the oxidation reaction of water by the composite body of nickel and iron. Examples of the metal element include Co, Mn, Ru, Ir, and so on. These metals can exist as a metal alone, a metal oxide, a metal hydroxide, or the like.

The oxidation catalyst layer 12 is formed, for example, by a known vacuum film forming method such as a sputtering method, a vapor deposition method, or an atomic layer deposition (ALD) method, or a known wet film forming method such as an electrodeposition method or an electroless plating method. It is preferable to employ the wet film forming method for repeatably realizing the above-described bonding state of nickel and iron.

The power supply 6 is electrically connected to the cathode 3 and the anode 4. The reduction reaction by the cathode 3 and the oxidation reaction by the anode 4 are performed using the electric energy supplied from the power supply 6. The power supply 6 and the cathode 3 may be connected, for example, by wiring, and the power supply 6 and the anode 4 may be connected, for example, by wiring. The case where the power supply 6 is connected with the cathode 3 and the anode 4 by the wiring or the like is advantageous in terms of the system because the components are separated for each function.

The power supply 6 may be the ordinary commercial power supply, a battery or the like, or, not limited to them, but may be a power supply that converts renewable energy into electric energy and supplies the electric energy. Examples of the power supply include a power supply that converts kinetic energy or potential energy such as wind power, water power, geothermal power, tidal power or the like into electric energy, a photoelectric conversion element that converts light energy into electric energy, a power supply such as a fuel cell or a storage battery that converts chemical energy into electric energy, an apparatus that converts vibrational energy such as sound into electric energy, and so on. The photoelectric conversion element has a function of performing charge separation by energy of emitted light such as sunlight. Examples of the photoelectric conversion element include a pin-junction solar cell, a pn-junction solar cell, an amorphous silicon solar cell, a multijunction solar cell, a single crystal silicon solar cell, a polycrystalline silicon solar cell, a dye-sensitized solar cell, an organic thin-film solar cell, and the like. The photoelectric conversion element may be stacked on at least one of the cathode 3 and the anode 4 inside the electrolytic solution tank 2.

The ion exchanger 5 can selectively allow the anion or the cation to pass therethrough. This makes it possible to make the electrolytic solutions 9, 10 in contact with the cathode 3 and the anode 4 respectively electrolytic solutions containing different substances, and to promote the reduction reaction and the oxidation reaction depending on the difference in ionic strength, the difference in pH, or the like. The ion exchanger 5 can be used to separate the first electrolytic solution 9 from the second electrolytic solution 10. The ion exchanger 5 has a function of allowing part of ions contained in the electrolytic solutions 9, 10 in which both the electrodes 3, 4 are immersed, namely, a function of blocking one or more kinds of ions contained in the electrolytic solutions 9, 10. This can differ, for example, the pH or the like between the two electrolytic solutions 9, 10.

Examples of the ion exchanger 5 include a cation exchange membrane such as Nafion (registered trademark) and Flemion (registered trademark), and an anion exchange membrane such as Neosepta (registered trademark) and Selemion (registered trademark). Besides, in the case where the movement of ions between the two electrolytic solutions 9 and 10 does not needs to be controlled, the ion exchanger 5 does not always have to be provided in the electrolytic solution tank 2. For example, when the electrolytic solutions 9, 10 are composed of the same electrolytic solution, a one-tank type electrolytic solution tank 2 may be used. The ion exchanger 5 may be, other than the ion membrane, packing filled with glass filter, agar, or the like, an insulating porous body of zeolite, oxide, or the like, or a polymer membrane through which the water molecules and ions can pass.

The electrochemical reaction device 1A may include a stirrer for accelerating the supply of the ions and materials to the surfaces of the cathode 3 and the anode 4. The electrochemical reaction device 1A may include measurement devices such as a thermometer, a pH sensor, a conductivity measuring device, an electrolytic solution analyzer, and a gas analyzer, and it is preferable that these measurement devices are included to control parameters in the electrochemical reaction device 1A. The electrochemical reaction device 1A may be any one of a batch-type reaction device and a flow-type reaction device. Note that in the case of the flow-type reaction device, it is preferable that supply flow paths and discharge flow paths for the electrolytic solutions 9, 10 are secured. At least parts of the cathode 3 and anode 4 included in the electrochemical reaction device 1A only need to be in contact with the electrolytic solutions 9, 10.

Next, the operation of the electrochemical reaction device 1A will be explained. Here, a case of using water and an aqueous solution containing carbon dioxide as the electrolytic solutions 9, 10 to reduce carbon dioxide so as to mainly produce carbon monoxide will be described. When a voltage of a bath voltage or higher is applied between the cathode 3 and the anode 4, the oxidation reaction of water (H₂O) occurs near the anode 4 in contact with the second electrolytic solution 10. As expressed in the following Formula (1), the oxidation reaction of H₂O contained in the second electrolytic solution 10 occurs, so that electrons are lost and oxygen (O₂) and hydrogen ions (H⁺) are produced. A part of the produced hydrogen ions (H⁺) move through the ion exchanger 5 into the first electrolytic solution 9.

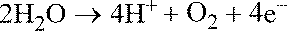

When the hydrogen ions (H⁺) produced on the anode 4 side reach the vicinity of the cathode 3 and electrons (e⁻) are supplied to the cathode 3 from the power supply 6, the reduction reaction of carbon dioxide (CO₂) occurs. As expressed in the following Formula (2), CO₂ contained in the first electrolytic solution 9 is reduced by the hydrogen ions (H⁺) moved to the vicinity of the cathode 3 and the electrons (e⁻) supplied from the power supply 6 to produce carbon monoxide (CO).

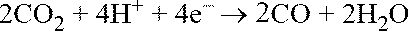

The reduction reaction of CO₂ is not limited to the CO production reaction but may be a production reaction of ethanol (C₂H₅OH), ethylene (C₂H₄), ethane (C₂H₆), methane (CH₄), methanol (CH₃OH), acetic acid (CH₃COOH), propanol (C₃H₇OH) or the like.

The power supply 6 needs to have an open-circuit voltage equal to or higher than a potential difference between a standard oxidation-reduction potential of the oxidation reaction and a standard oxidation-reduction potential of the reduction reaction. For example, the standard oxidation-reduction potential of the oxidation reaction in the Formula (1) is 1.23 [V/vs. NHE]. The standard oxidation-reduction potential of the reduction reaction in the formula (2) is -0.1 [V/vs. NHE]. In this case, the open-circuit voltage needs to be 1.33 [V] or higher in the reactions of the Formula (1) and the Formula (2). The open-circuit voltage of the power supply 6 is preferably set to be higher, by a value of overvoltages or more, than the potential difference between the standard oxidation-reduction potential of the oxidation reaction and the standard oxidation-reduction potential of the reduction reaction. For example, each of the overvoltages of the oxidation reaction in the Formula (1) and the reduction reaction in the Formula (2) is 0.2 [V]. The open-circuit voltage is preferable to be 1.73 [V] or higher in the reactions of the Formula (1) and the Formula (2).

The electrochemical reaction device 1A in the embodiment uses a metal substrate having resistance to the electrolytic solutions 9, 10, as the conductive substrate 11 of the anode 4. In the case of using a conductive substrate 11 having no resistance to the electrolytic solutions 9, 10, when, for example, an electrolytic solution containing at least one of carbon dioxide, hydrogen carbonate ions, and carbonate ions is used as the first electrolytic solution 9 or the second electrolytic solution 10, the conductive substrate 11 is likely to elute in the electrolytic solution. When the conductive substrate 11 elutes, the oxidation catalyst layer 12 is more likely to peel off. This is a factor that causes a decrease in durability of the anode 4. In contrast to this, use of the metal substrate composed of titanium, titanium alloy, or stainless steel having resistance to the electrolytic solutions 9, 10 as the conductive substrate 11 can suppress the elution of the conductive substrate 11 in the electrolytic solutions 9, 10. Accordingly, it becomes possible to suppress peeling of the oxidation catalyst layer 12 from the conductive substrate 11 and improve the durability of the anode 4.

### Second Embodiment

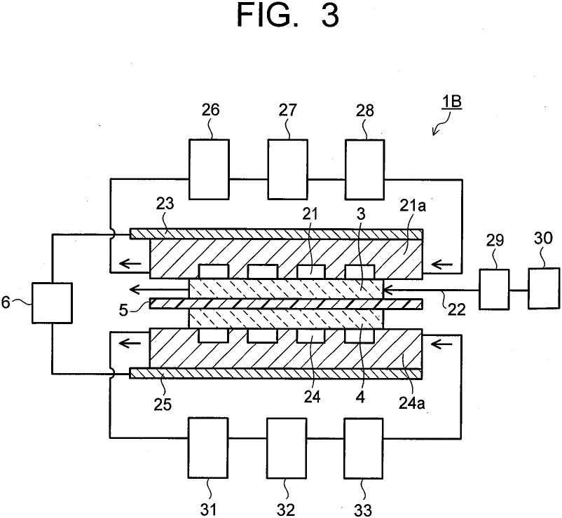

An electrochemical reaction device 1 in a second embodiment will be explained referring to FIG. 3. An electrochemical reaction device 1B according to the second embodiment illustrated in FIG. 3 includes a cathode 3, an anode 4, an ion exchanger 5, a flow path 21 for a cathode solution (first electrolytic solution), a flow path 22 for gas containing CO₂ (simply described as CO₂ gas in some cases), a cathode current collector 23, a flow path 24 for an anode solution (second electrolytic solution), an anode current collector 25, and a power supply 6.

The electrochemical reaction device 1B illustrated in FIG. 3 is different from the electrochemical reaction device 1A in the first embodiment, in the contact type of the cathode solution (first electrolytic solution) and CO₂ gas with the cathode 3, the contact type of the anode solution (second electrolytic solution) with the anode 4, and the connection type of the cathode 3 and the anode 4 with the power supply 6. The configurations of the parts other than them, for example, the cathode 3, the anode 4, the ion exchanger 5, the cathode solution (first electrolytic solution), the anode solution (second electrolytic solution) and so on are the same as those in the first embodiment.

The cathode solution flow path 21 is arranged to face the cathode 3. To the cathode solution flow path 21, a first solution system including a cathode solution tank 26, a pump 27, and a reference electrode 28 is connected and configured such that the cathode solution circulates through the cathode solution flow path 21. The CO₂ gas flow path 22 is provided so that the CO₂ gas flows through the cathode 3. Into the CO₂ gas flow path 22, the CO₂ gas is introduced from a CO₂ gas cylinder 30 via a flow rate control unit 29. The gas passed through the cathode 3 contains a gaseous product such as CO and is sent to a not-illustrated product collection unit. The anode solution flow path 24 is arranged to face the anode 4. To the anode solution flow path 24, a second solution system including an anode solution tank 31, a pump 32, and a reference electrode 33 is connected and configured such that the anode solution circulates through the anode solution flow path 24.

The power supply 6 is electrically connected to the cathode 3 and the anode 4 via the cathode current collector 23 and the anode current collector 25. The cathode current collector 23 is electrically connected to the cathode 3 via a first flow path plate 21a forming the cathode solution flow path 21. The anode current collector 25 is electrically connected to the anode 4 via a second flow path plate 24a forming the anode solution flow path 24. It is preferable to use a material low in chemical reactivity and high in conductivity for the first and second flow path plate 21a, 24a. Examples of the material include metal materials such as Ti and SUS, carbon materials, and so on. Note that though the configuration having the cathode solution flow path 21 is illustrated in FIG. 3, the flow path for the cathode solution and the solution system may be omitted in the case of using the same electrolytic solution for the cathode solution and the anode solution.

In the electrochemical reaction device 1B in the second embodiment, the reduction reaction of CO₂ at the cathode 3 and the oxidation reaction of H₂O at the anode 4 are performed by passing current from the power supply 6 to the cathode 3 and the anode 4 while making the cathode solution (first electrolytic solution) flow through the cathode solution flow path 21 and bringing the cathode solution into contact with the cathode 3, making CO₂ gas flow through the CO₂ gas flow path and the cathode 3 and bringing the CO₂ gas into contact with the cathode 3, and making the anode solution (second electrolytic solution) flow through the anode solution flow path 24 and bringing the anode solution into contact with the anode 4. Also in the electrochemical reaction device 1B, the use of the metal substrate made of titanium, titanium alloy, or stainless steel as the conductive substrate 11 of the anode 4 can suppress the elution of the conductive substrate in contact with the anode solution (second electrolytic solution). Accordingly, it becomes possible to suppress the peeling of the oxidation catalyst layer from the conductive substrate to improve the durability of the anode 4.

### EXAMPLES

Next, examples and their evaluation results will be described.

### Example 1, Comparative Example 1

In this example, an anode produced using a titanium substrate as a conductive substrate (Example 1) and an anode produced using a nickel substrate as a conductive substrate (Comparative Example 1) were used to assemble electrochemical reaction devices illustrated in FIG. 1, and their durabilities were compared.

The anode in Example 1 was produced as follows. First, a plate electrode was mounted on a titanium mesh substrate of 2 × 2.5 cm², and the titanium mesh substrate was immersed in an aqueous solution (0.1 M) containing a nickel sulfate hexahydrate (NiSO₄•6H₂O) and iron sulfate heptahydrate (FeSO₄•7H₂O) in a manner that the aforementioned aqueous solution was not in contact with the plate electrode. A Pt mesh electrode was used as a counter electrode, and -0.9 V was applied to an Ag/AgCl (saturated KCl) reference electrode to reach -2C per 1 cm² to electrodeposit a ferronickel hydroxide on the titanium mesh substrate. In the ferronickel hydroxide, the content of iron was 33 mass%. By the above process, the anode in Example 1 was produced.

For the anode in Comparative Example 1, a ferronickel hydroxide was electrodeposited on a nickel porous body by the same process as that in Example 1 except that a nickel porous body substrate was used in place of the titanium mesh substrate. By the above process, the anode in Comparative Example 1 was produced.

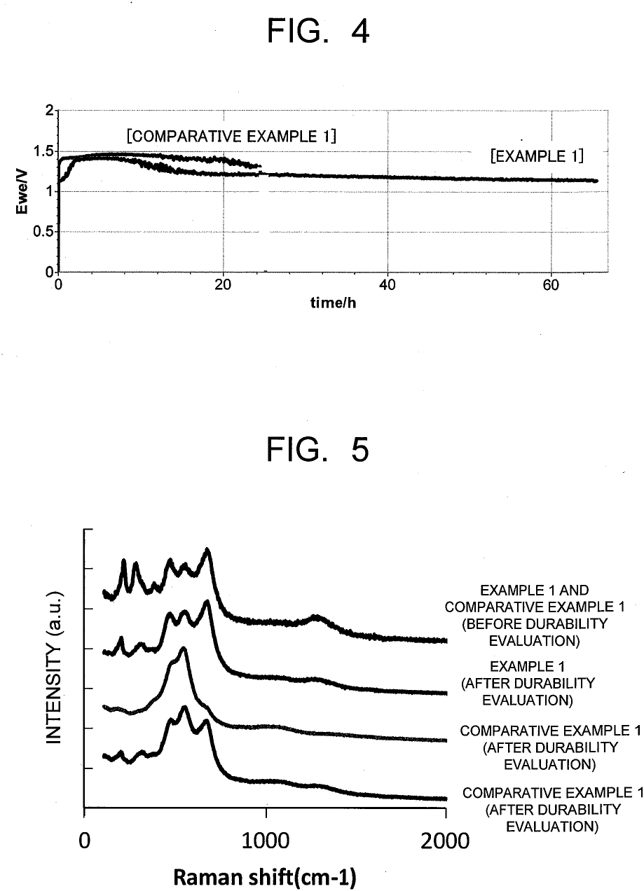

Regarding the ferronickel hydroxides (oxidation catalysts) of the anodes in Example 1 and Comparative Example 1, the Raman spectra were measured by the Raman spectroscopic analysis. Their results are illustrated in FIG. 5. FIG. 5 illustrates Raman spectra before and after the evaluation of durabilities. The Raman spectrum of the anode in Example 1 has a first peak in a Raman shift of 170 cm⁻¹ or more and 350 cm⁻¹ or less, a second peak in a Raman shift of 450 cm⁻¹ or more and 570 cm⁻¹ or less, and a third peak in a Raman shift of 650 cm⁻¹ or more and 700 cm⁻¹ or less. From this, it is confirmed that the bonding state of nickel and iron is composed of Ni(OH)₂, NiOOH, and FeOOH in the ferronickel hydroxide in Example 1.

Further, the anodes in Example 1 and Comparative Example 1 were installed in H-type cells and counter electrodes of Pt mesh were installed as cathodes. An ion exchanger was installed in the anode and the cathode, and an aqueous solution (1 M) made by dissolving potassium hydrogen carbonate (KHCO₃) was used as the electrolytic solution. A current of 100 mA/cm² was applied to the Ag/AgCl (saturated KCl) reference electrode to perform constant-current measurement. FIG. 4 is a chart illustrating the relationship between time and the anode potential by the constant-current measurement of electrochemical reaction cells using the anodes in Example 1 and Comparative Example 1. In the constant-current measurement result using the anode in Example 1, a potential lower than that in the constant-current measurement result using the anode in Comparative Example 1 is maintained, thus showing high activity. Note that in the constant-current measurement using the anode in Comparative Example 1, peeling of the oxidation catalyst layer was recognized in the middle of the measurement, and therefore energization was stopped at a lapse of 24 hours.

FIG. 5 illustrates the results of the above-described Raman spectroscopic analysis measured before and after the evaluation of durabilities about the anodes in Example 1 and Comparative Example 1. In Example 1, the Raman spectrum does not change between before and after the evaluation, thus showing that the state of the oxidation catalyst layer is maintained. In Comparative Example 1, the spectrum changes after the evaluation and the nickel oxide of the substrate is observed, thus showing that the catalyst partially peels. In other words, it is found that the anode in Example 1 is excellent in durability because the peeling of the oxidation catalyst layer is not recognized even after the evaluation of the durability.

### Example 2

An anode in Example 2 was produced in the same process as that in Example 1 except that a potential was applied until reaching -10 C per 1 cm² when electrodepositing a ferronickel hydroxide on a titanium mesh substrate. This anode was installed in a high current density cell (electrochemical reaction cell) whose configuration is illustrated in FIG. 3, and an Ag electrode (manufactured by Dioxide Materials) was installed as a cathode. An anion exchange membrane was installed between the anode and the cathode, and an aqueous solution (1 M) made by dissolving potassium hydrogen carbonate (KHCO₃) was used as the electrolytic solution. A current of 500 mA/cm² was applied between the anode and the cathode to perform constant-current measurement for eight hours.

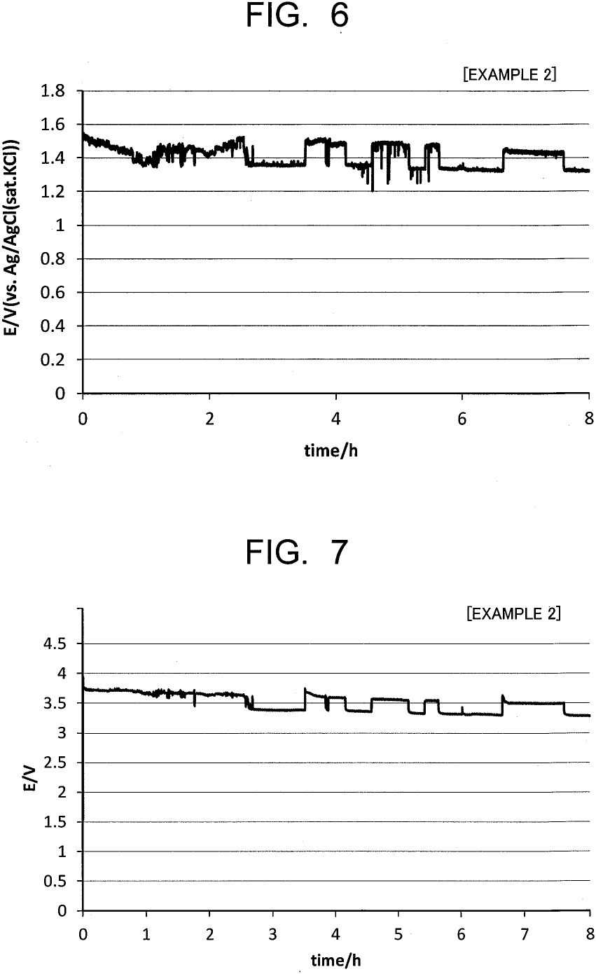

FIG. 6 illustrates the relationship between time and the anode potential by the constant-current measurement of the electrochemical reaction cell using the anode in Example 2. FIG. 7 illustrates the relationship between time and the cell voltage by the constant-current measurement of the electrochemical reaction cell using the anode in Example 2. It is found that the anode is excellent in durability because both changes in the anode potential and the cell voltage are small in the constant-current measurement for eight hours.

The configurations in the embodiments can be applied in combination and partially replaced. While certain embodiments of the present invention have been described herein, these embodiments have been presented by way of example only, and are not intended to limit the scope of the inventions. The embodiments described herein may be embodied in a variety of other forms; furthermore, various omissions, substitutions and changes may be made without departing from the spirit of the inventions. The embodiments and modifications fall within the scope and spirit of the inventions and fall within the scope of the inventions as set forth in claims and their equivalents.

What is claimed is:

1. A method of electrolyzing carbon dioxide, comprising:
supplying at least one of a gas containing carbon dioxide and a first electrolytic solution containing carbon dioxide to a first accommodation part of an electrolysis cell so that the gas or the first electrolytic solution is in contact with a reduction electrode in the first accommodation part, the electrolysis cell including the reduction electrode, an oxidation electrode, the first accommodation part, and a second accommodation part;
supplying a second electrolytic solution containing water and at least one selected from the group consisting of carbon dioxide, hydrogen carbonate ions, and carbonate ions to the second accommodation part of the electrolysis cell so that the second electrolytic solution is contact with the oxidation electrode in the second accommodation part, wherein the oxidation electrode comprises a conductive substrate made of a metal material including titanium, titanium alloy, or stainless steel and an oxidation catalyst layer provided on the conductive substrate and made of a composite body contains 20 mass% or more and 70 mass% or less of iron and a balance of nickel, and a bonding state of nickel and iron in the composite body is composed of Ni(OH)₂, NiOOH, and FeOOH; and
supplying an electric current from a power supply to the reduction electrode and the oxidation electrode, to reduce the carbon dioxide in the reduction electrode and produce a carbon compound.

2. The method of claim 1, wherein the second electrolytic solution has pH higher than that of the first electrolytic solution.

3. The method of claim 1, wherein the conductive substrate comprises a porous substrate, a mesh substrate, a thin film shape substrate, a particle shape substrate, or a wire shape substrate.

4. The method of claim 1, further comprising:
forming the oxidation catalyst layer on the conductive substrate by a sputtering method, a vapor deposition method, an atomic layer deposition method, an electrodeposition method, or an electroless plating method.
